(19) United States
(12) Patent Application Publication
(10) Pub. No.: US 2012/0263895 A1
(43) Pub. Date: Oct. 18, 2012

(54) INTERCHANGEABLE DECORATION AND ARTWORK FOR JEWELRY AND CLOTHING

(76) Inventors: PERRY JETER, JR., BEXLEY, OH (US); MATTHEW B. WORRICK, BRISTOW, VA (US); ROBERT J. UNCZUR, FAIRFAX, VA (US)

(21) Appl. No.: 13/447,144

(22) Filed: Apr. 13, 2012

Related U.S. Application Data
(60) Provisional application No. 61/476,239, filed on Apr. 15, 2011.

(51) Int. Cl. A41D 27/08; B23P 17/04; A41D 20/00; A43B 23/24; A44C 25/00; B32B 1/06

(52) U.S. Cl. 428/34.1; 428/35.7; 428/35.6; 428/34.6; 428/36.8; 2/170; 36/136; 29/428

(57) ABSTRACT

An interchangeable accessory comprised of a plaque or decorative element and a housing with a cavity. Emblems, logos, indicia, or other types of decoration are displayed on the decorative element, and the decorative element is releasably mounted within the cavity of the housing. The housing can be attached to a wrist-worn band, sweat shirt strings, a key chain or the like, or it can be directly mounted on items of wearing apparel, such as shoes.

### CROSS REFERENCE TO RELATED APPLICATION(S)

This application claims the benefit of U.S. Provisional Application No. 61/476,239, entitled “Interchangable Decoration and Artwork for Jewelry and Clothing,” filed on Apr. 15, 2011, the subject matter of which is hereby incorporated therein by reference in its entirety.

### TECHNICAL FIELD OF THE INVENTION

The present invention relates to the general art of jewelry and clothing, and to the particular field of clothing and jewelry artwork and decoration.

### BACKGROUND OF THE INVENTION

There are a number of ways that jewelry and decorative items with interchangeable symbols and artwork are desirable by the consumer within the marketplace.

For one example, there is high fashion elegant jewelry such as bracelets, cuff links, studs for tuxedo shirts, rings, and earrings and pendants but these enjoy a limited market due to their expense. This is particularly unfortunate as jewelry is most striking when closely matched to the wearer's other apparel and accessories (e.g. tie and/or handkerchief). In order to expand the consumer market for such jewelry by making each item more versatile, attempts have been made to introduce the concept of interchangeability into the high-end market. To date, such attempts have involved either relatively-complex or difficult-to-handle mechanisms.

Furthermore, it would be desirable to be able to change the appearance of everyday clothing items. For example, sweat shirts have become quite common and varieties are worn in a any number of settings ranging from an outing to a ball game to a fashionable accessory for an evening out. As such, it would be desirable to have a means for accessorizing a sweat shirt in an efficient and easy manner. Furthermore, shoes are often selected and worn with an eye to making a personal statement, and an ability to change their appearance to taste would be desirable as well. Also, in some situations, there is a desire to change the appearance of accessories, such as one's key chain or the like.

Therefore, there is a need for a means for changing the appearance of many items that are carried or worn in an easy, efficient and cost-effective manner.

### SUMMARY OF THE INVENTION

These, and other objects are achieved by a decorative accessory which includes a plaque or element on which logos, indicia, or other types of decoration are displayed and which is releasably mounted on a housing. The housing can be attached to wrist-worn band, sweat shirt strings, a key chain or the like, or directly mounted on items of wearing apparel, such as shoes.

### BRIEF DESCRIPTION OF THE DRAWING FIGURES

FIG. 1 is a schematic perspective view of an embodiment of the accessory of the present invention.

FIG. 1A is a top plan view of the accessory shown in FIG. 1.

FIG. 2 is a solid perspective view showing a basic mounting used in the embodiment shown in FIG. 1.

FIG. 2A is a top plan view of the embodiment of the accessory shown in FIG. 1.

FIG. 3 shows the embodiment of the accessory shown in FIG. 1 with the accessory parts fully engaged.

FIGS. 4A-4B are top perspective views of an embodiment of the invention, know “Fan Bandz.”

FIGS. 5A-5B are top perspective views of another form of the invention known as “Uniband.”

FIGS. 6A-6D are perspective views of another embodiment of the invention.”

FIGS. 7A-7E show another embodiment of the invention.

FIGS. 8A-8C show another embodiment of the invention.

FIGS. 9A-9D are, respectively, a top plan solid view, solid perspective view, a top plan schematic view and a side schematic view of another embodiment of the invention.

FIGS. 9E-9F are, respectively, a top plan schematic view and a side schematic view of another embodiment of the invention.

### DETAILED DESCRIPTION OF THE PREFERRED EMBODIMENT OF THE INVENTION

Other objects, features and advantages of the invention will become apparent from a consideration of the following detailed description and the accompanying drawings. The following descriptions are made referring to the figures, wherein like reference number refer to like features throughout this description.

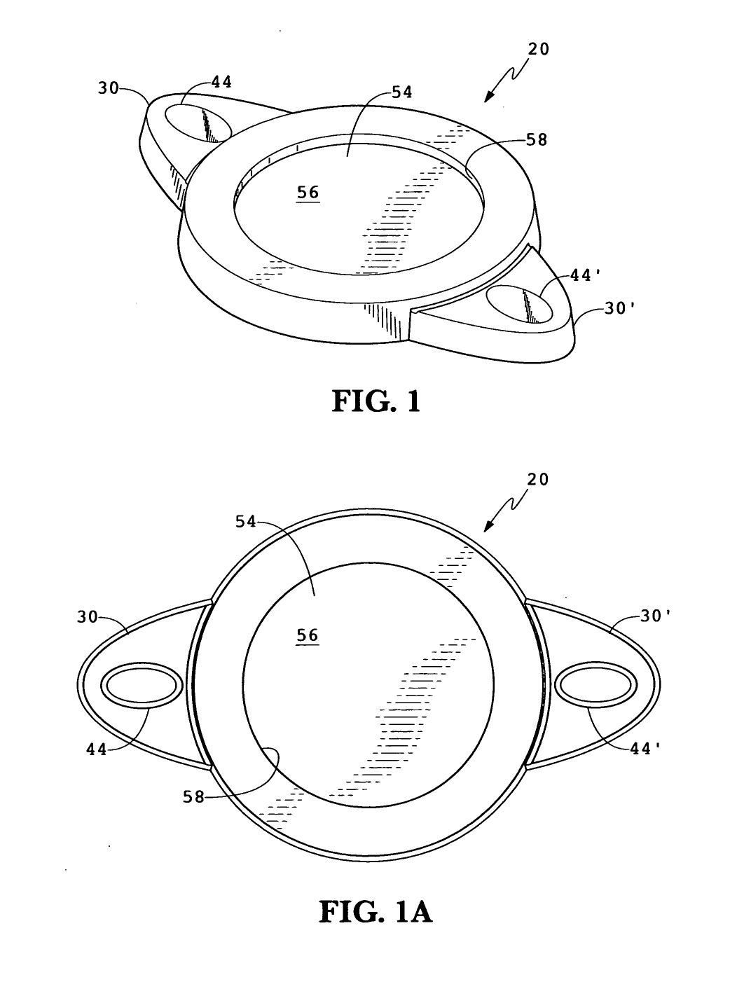

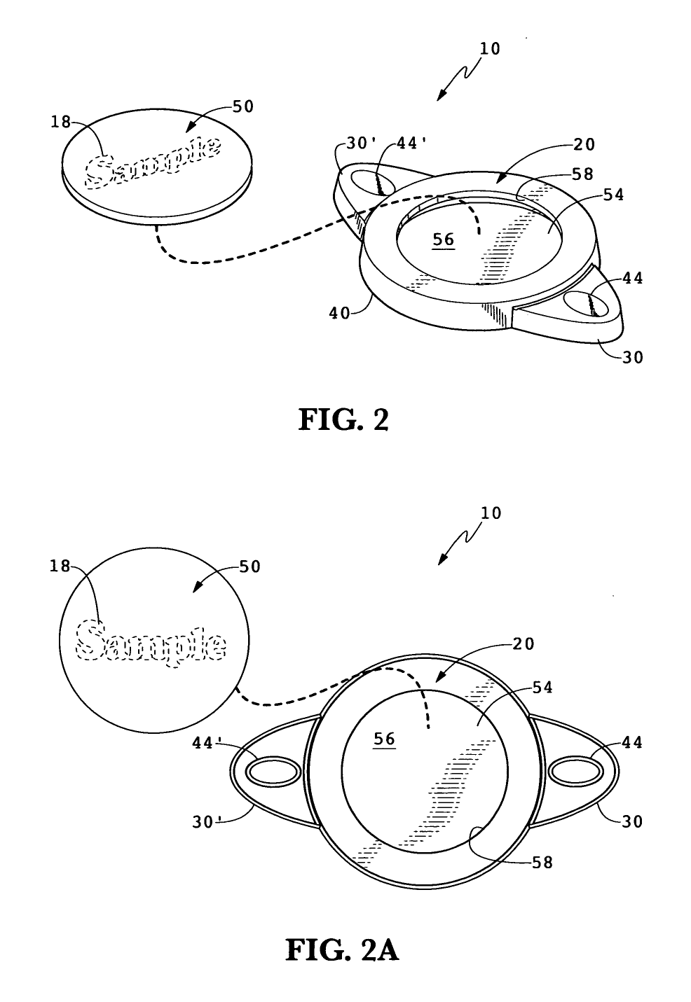

One embodiment of the present invention is shown in FIGS. 1-3. Turning briefly specifically to FIG. 2, an accessory 10 is shown that can be mounted on wearing apparel, such as the strings of a sweat shirt. The accessory 10 has an emblem 18, and it is to be understood that the term emblem can mean any wording, symbol(s), artwork or some combination thereof. The emblem can display, for example, the logo or emblem of a college, company, fraternity, personal name, sports team, or other suitable insignia. It should be understood that this list is representative and not limiting.

The accessory 10 includes a housing 20 and returning to FIGS. 1-3, the housing 20 in this embodiment is comprised of a rounded portion with a cavity 54, and two ears 30 and 30′ affixed to the outer periphery 40 thereon, resulting in an oval-shaped structure. An aperture, such as aperture 44, 44′ is defined through each respective ear and the ears are oriented on a straight line with respect to each other and along a major axis of the housing 20.

Returning specifically to FIGS. 2 and 2A, a disc-like decorative element 50, or plaque, contains an emblem 18 thereon and is mounted in the cavity 54 defined in the housing 20 to be displayed when the accessory 10 is worn. The decorative element 50 can be constructed of any suitable material such as, but not limited to, a metal or metals, plastics, glass, wood, crystal, rubber, rubberized PVC or other rubberized material, leather, silicone, a ceramic, or recycled material. The disk element 50, as well as, respectively, the housing 20, is not limited to a rounded shape, and can be of any suitable shape, including circular, oval or polygonal.

A planar surface 56 forms the bottom wall of cavity 54 and in this embodiment, the decorative element 50 is retained in place by frictional contact with the peripheral inner wall 58 of the housing 20, and both the decorative element 50 and at least the portion of the housing 20 in contact with the element 50 are comprised of a suitable material to maintain this frictional contact.

A form of the accessory 10 is shown which has a flexible decorative element 50, formed of rubber or the like, and which is releasably accommodated in cavity 54, defined by a bottom wall 56 and a wall 58 that is flexible. The inner circumference of wall 58 is slightly smaller than the outer circumference of element 50 so wall 58 has to flex radially outwardly to accommodate disc 50. Once disc 50 is inserted into cavity 54, it will be held in place by frictional contact between wall 58 and outer periphery of the decorative element 50. Wall 58 is flexed radially outwardly to release the disc-like element whereby it can be removed and replaced as desired. However, the frictional contact between the wall and the outer periphery of element 50 will retain the element in place when desired. The two portions engage each other, thereby removably securing the plaque to the housing.

Turning briefly to FIG. 3, the accessory 10 is shown when the decorative element 20 is removably secured to the housing 20, within the peripheral wall 58. In this embodiment, the cavity 54 has a diameter of about 24-25 mm, and a depth of about 2 mm. The decorative element has a thickness of about 3 mm.

Returning back to FIGS. 1-3, strings, such as are associated with a sweatshirt, can be threaded through the apertures 44, 44′ to mount the accessory 10 on the wearing apparel. Accessory 10 can also be attached to a pull element of a zipper of a jacket or sweatshirt. Additionally, accessory 10 can also be attached to a key chain.

In an alternative embodiment, the decorative element 50 can contain a magnet and a magnet can be embedded in the bottom wall 56, and the two magnets oriented to be attracted to each other.

In another alternative embodiment, either the decorative element 50 or the bottom wall 56 can be comprised of a magnetically attractive material, and the other have a magnet embedded therein which attracts the other to magnetically hold the element 50 onto the housing 20. In another specific embodiment, at least the bottom wall 56 of the housing 20 is magnetized to magnetically hold the decorative disc element 50, which is formed of metal or other material which will be attracted to the magnetized bottom wall 56 in the cavity 54, when the accessory 10 is being worn.

In the embodiments involving magnets and/or magnetically charged materials, the magnetic attraction between the decorative element 50 and the housing 20 prevents accidental disengagement of the decorative element 50 element during use. When the wearer wishes to remove the decorative element 50 from engagement with the housing 20, he or she can simply apply a force sufficient to break the magnetic bond between the element 50 and the housing 20 and lift the element 50 from the housing 20.

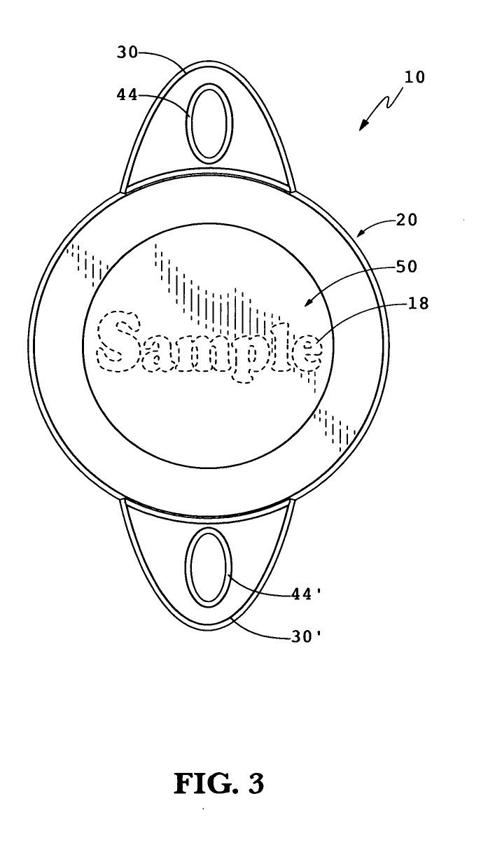

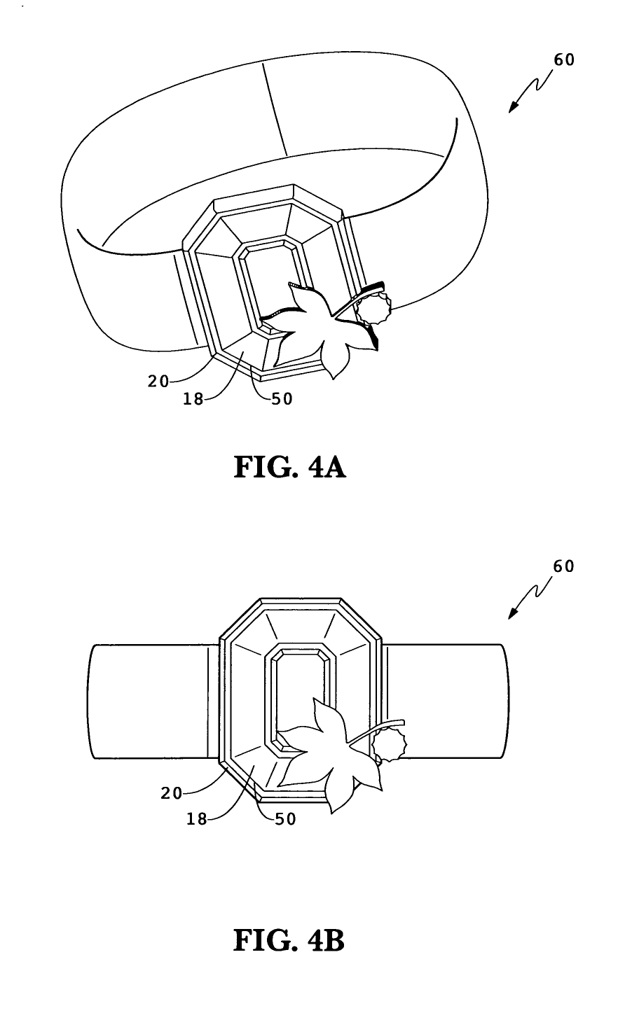

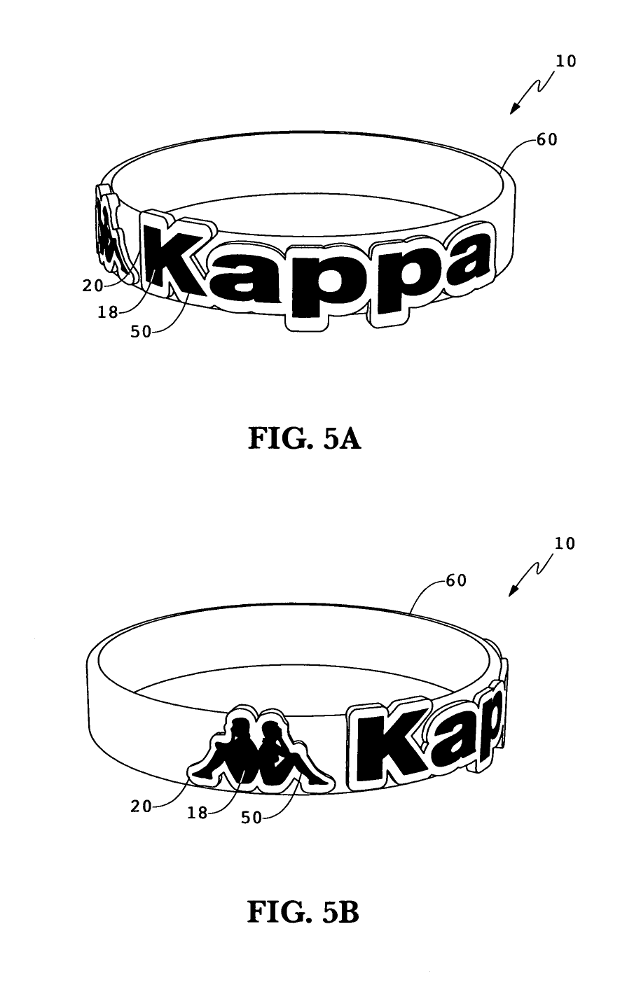

Another form in which the accessory is wrist-worn is shown in FIGS. 4A-6D. A wrist-worn portion 60 with two arms is attached to the housing 20 on either side, to which, as in previous embodiments, the decorative element 50, with emblem 18, is removably secured. The wrist portion is capable of being removably secured to a wearer's wrist by any suitable means known in the art, such as a clasp or hook and loops. The decorative element 50 can be removably secured to the housing 20 by any of the means shown in other embodiments herein.

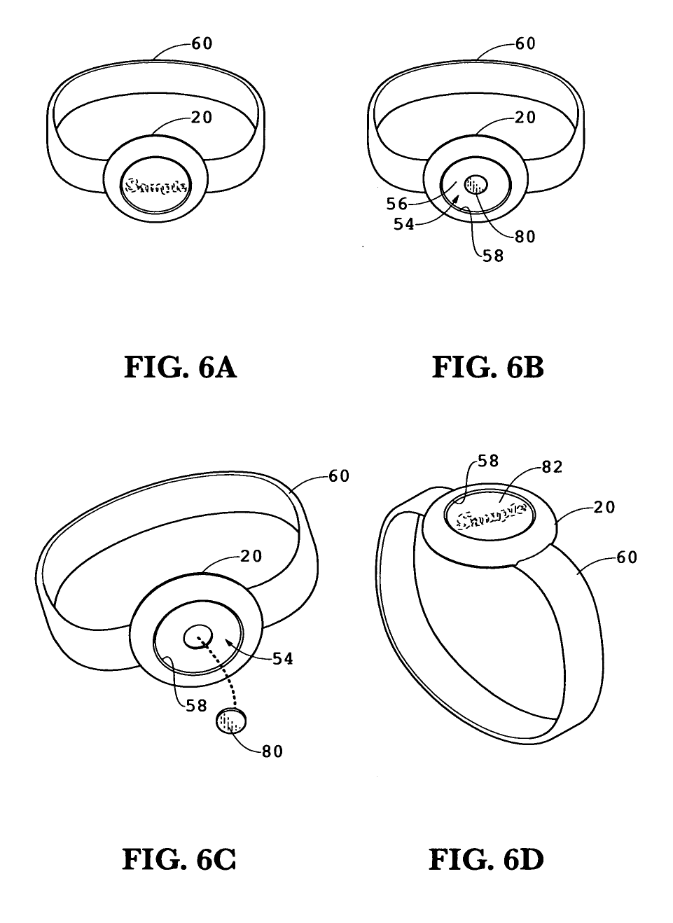

In the wrist embodiment shown in FIGS. 6A-6D, the accessory 10 includes the housing 20 having a circular perimeter and a cavity 54 defined therein with a planar surface 56 forming the bottom wall thereof. In this particular embodiment, the bottom wall 56 is magnetized, such as by having a magnet 80 embedded therein, to magnetically hold the element 50, which is comprised of material capable of being magnetically attracted, having the emblem 18, which can then be worn and displayed on a wearer's wrist. The decorative element 50 can be metal and coin-shaped metal, or a metallic coin 82 can be placed therein.

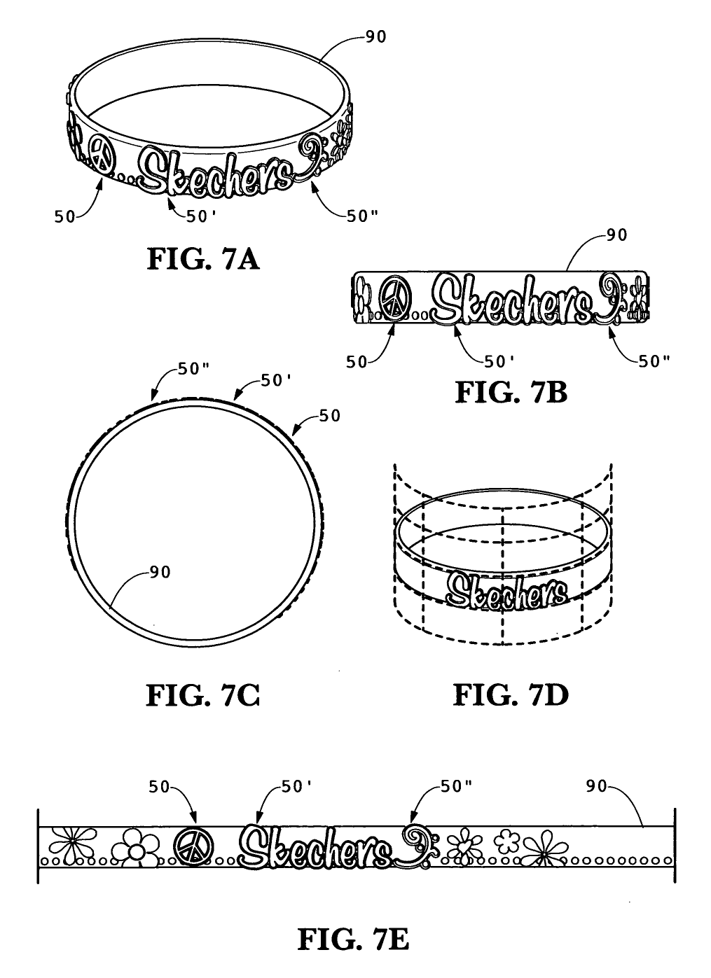

Yet another form of the accessory 10 is shown in FIGS. 7A-7E and includes a simple wrist-worn band 90, wherein the element 50 can be a single or, as in this embodiment, multiple decorative elements 50, 50′, 50″ with a variety of emblems 18, 18′, 18″ and the elements are mounted on the simple band 90, thereon to be displayed when the band 90 is worn. The decorative elements, 50, 50′ 50″ can be secured by any of the means shown in other embodiments herein. In this embodiment, the band 90 is formed of magnetic material and the decorative elements 50, 50′, 50″ are formed of material which will be magnetically held on the band. The decorative elements 50, 50′, 50″ and their emblems 18, 18′, 18″ can be removed and replaced as desired.

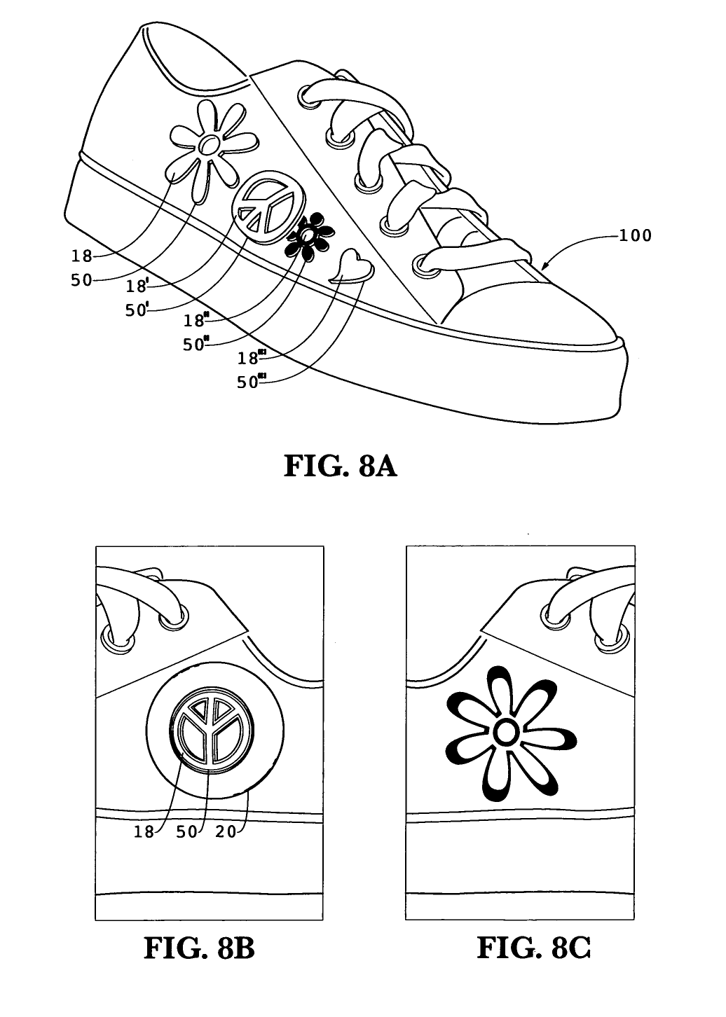

Yet another form of the accessory is shown in FIGS. 8A-8C and includes decorative elements 50, 50′, 50″ and 50′″ which are removably mounted on a shoe 100. Elements 50, 50′, 50″ and 50′″, gas in previous embodiments, have emblems 18, 18′, 18″ and 18,” which can have any of the insignia, logos, artwork or printing as described herein. The decorative element can be removably secured to the respective housings by any of the means as described in other embodiments herein.

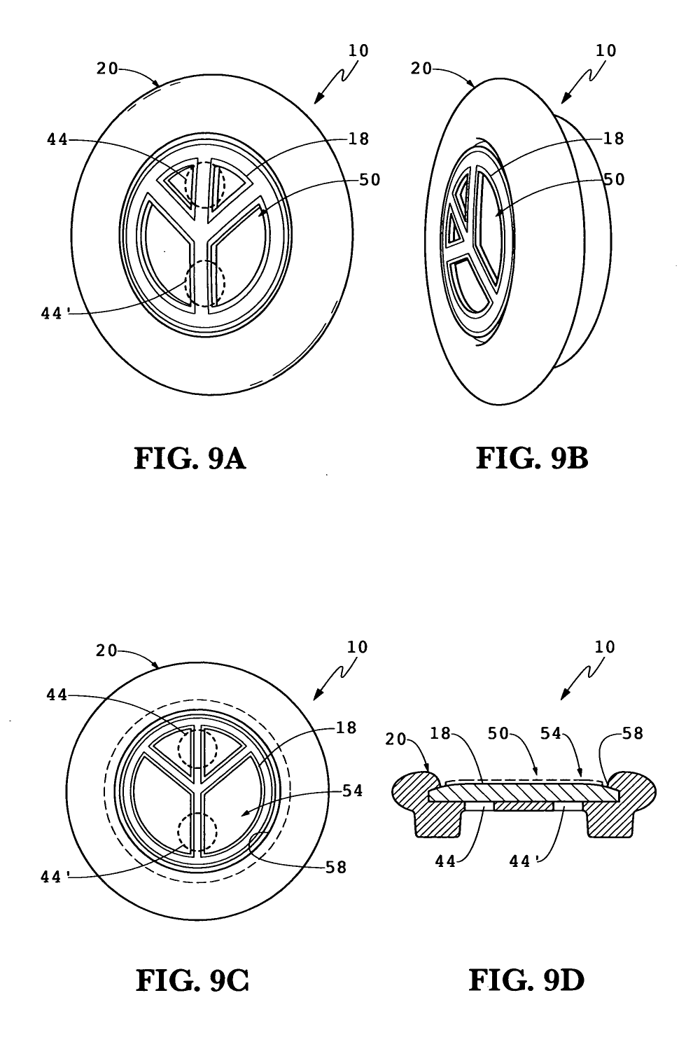

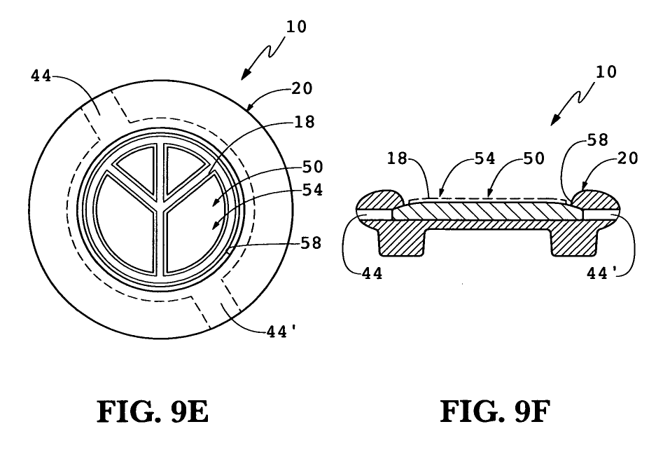

Further embodiments of the invention illustrating other ways the disk element 50 can be secured within the housing 20, as well as other arrangements for securing the accessory 10 to other items such as shoes or jewelry via chords, shoelaces, straps or the like, are shown by FIGS. 9A-F. Though the decorative elements of these embodiments can be removably secured by any means in other embodiments herein, in these specific embodiments, and looking specifically to FIGS. 9D and 9F, the circumference of the cavity wall 58 is configured to be slightly less at the top of wall 58 then at the bottom wall, and so that the circumference at the top is less than the circumference of the disk element 50. This can be accomplished by a sloping or, as shown in the embodiment of FIGS. 9C-9D, a step-like configuration of the wall 58, wherein an overhanging lip is formed at the top portion of the wall 58.

In these embodiments, in which the circumference of the cavity wall 58 is slightly smaller than the outer circumference of element 50, the element, as in previous embodiments, is held in place by frictional contact between wall 58 and the decorative element 50, and the cavity wall 58 is flexed radially outwardly to accommodate the element 50, and flexed radially outwardly again to release the decorative element 50, whereby it can be removed and replaced as desired.

In the embodiment shown in FIGS. 9E-F, apertures 44, 44′ are located at the cavity wall 58, directly across from each other, or in other locations along the wall relative to each other as suitable. A chord, shoelace, a strap, string or the like is threaded through one aperture 44, across the cavity 54 and out through the second apertures 44′, thereby securing the accessory 10 to the chord, shoelace, chord, strap, string or the like.

In the embodiment shown in FIGS. 9C-D, the apertures 44, 44′ are located at the planar bottom wall 56, a suitable distance apart. Here, a chord, shoelace, a strap, string or the like is threaded through one aperture 44, into the cavity 54 and back out through the second aperture 44′, thereby, as in the embodiment of FIGS. 9E-F, securing the accessory 10 to the chord, shoelace, chord, strap, string or the like.

Similarly, other suitable placements and arrangements of the apertures involving the cavity wall 58 and/or planar bottom 56 for securing the accessory 10 can be used.

By either of the embodying forms shown in FIGS. 9C-D or 9E-F, or other similar suitable embodiments, respectively, the accessory 10 can be easily and indirectly secured to, e.g. shoes, a hooded sweatshirt, or any suitable object for use. As an example, if the chord of a sweatshirt is knotted after being threaded through the apertures 44, 44′ the accessory can provide a convenient handle for pulling the chord to tighten it, and can help with retention of the chord by preventing it from retreating within its openings in the sweatshirt, where the chord can be difficult to pull back out or even unreachable.

It will be understood by one skilled in the art that, in addition to those discussed, other emblems, logos and indicia can be used and the examples herein are not intended to be limiting. Further, the emblem 18 for the decorative element 50 can be created using any suitable process in the art such as, but not limited to, engraving, embossing, printing, sewing, painting and use of colored material within the decorative element 50 itself.

It should also be understood that housing 20 can be constructed, depending upon the particular embodiment, of any suitable material or combination of materials known in the art. For example, the housing of the magnetic embodiments can be constructed of any suitable material such as a metal or metals, or plastics, and the housing of the non-magnetic flexible embodiments can be constructed of any suitable flexible material such as, but not limited to, plastics, rubber, rubberized PVC or other rubberized material, silicone, or recycled material.

It is to be understood that while certain forms of the present invention have been illustrated and described herein, the expression of these individual embodiments is for illustrative purposes and should not be seen as a limitation upon the scope of the invention. It is to be further understood that the invention is not to be limited to the specific forms or arrangements of parts described and shown.

What is claimed is:

1. An interchangeable decorative accessory, comprising a housing and a decorative element, wherein the housing is further comprised of a bottom planar wall and a peripheral wall surrounding and attached to the planar wall,
wherein the peripheral wall is comprised of an inner surface facing the planar wall and a top surface,
and wherein the top surface of the peripheral wall is above the planar wall, such that the decorative element is capable of resting on top of the planar surface and within the peripheral wall in proximity or contact with the peripheral wall inner surface.

2. An interchangeable decorative accessory as in claim 1, wherein the decorative element is further comprised of an emblem on at least one surface.

3. An interchangeable decorative accessory as in claim 1, wherein the housing is further comprised of two ears attached to opposite sides of the housing, and wherein the ears are each configured to define an aperture within each respective ear.

4. An interchangeable decorative accessory as in claim 1, wherein the decorative element has a shape that is circular, oval or polygonal.

5. An interchangeable decorative accessory as in claim 1, wherein the decorative element is comprised of a metal, two or more metals, plastics, glass, wood, crystal, rubber, rubberized PVC, other rubberized material, leather, silicone, a ceramic, or recycled material.

6. An interchangeable decorative accessory as in claim 1, wherein the housing is comprised of a metal, two or more metals, plastic, rubber, rubberized PVC, other rubberized material, or silicone.

7. An interchangeable decorative accessory as in claim 1, wherein the housing is comprised of a material capable of maintaining frictional contact with the decorative element sufficient to secure the decorative element within the peripheral wall, and wherein the material is sufficiently flexible to be capable of flexing radially outward to either secure or release the decorative element.

8. An interchangeable decorative accessory as in claim 1, wherein the decorative element has a circumference slightly greater than that of the peripheral wall.

9. An interchangeable decorative accessory as in claim 1, further comprising a magnet mounted to the decorative element and a second respective magnet mounted to the bottom planar wall, and wherein the magnets are attracted to each other.

10. An interchangeable decorative accessory as in claim 1, further comprising a magnet,
wherein either the bottom planar wall or the decorative element is comprised of a magnetically attractive material, and the magnet is mounted to the other.

11. An interchangeable decorative accessory as in claim 1, further comprising a pair of arms attached to each respective side of the housing to form a wrist band.

12. An interchangeable decorative accessory as in claim 1, further comprising a wrist band, and wherein the housing is mounted on the surface of the wrist band.

13. An interchangeable decorative accessory as in claim 1, further comprising a shoe, and wherein the housing is mounted on the surface of the shoe.

14. An interchangeable decorative accessory as in claim 1, wherein the circumference of the peripheral wall at the top of the of the wall away from the bottom planar wall is less than the circumference of the peripheral wall at the bottom towards the planar wall,
and wherein the circumference at the top of the planar wall is less than the circumference of the decorative element.

15. An interchangeable decorative accessory as in claim 1, wherein the planar wall is shaped so as to define a pair of apertures therein.

16. An interchangeable decorative accessory as in claim 1, wherein the peripheral wall is shaped so as to define a pair of apertures therein.

17. A method for using an interchangeable decorative accessory, comprising the steps of:
providing a housing comprised of a planar wall and a peripheral wall surrounding and attached to the planar wall,
wherein the peripheral wall is comprised of an inner surface facing the planar wall and a top surface,
and wherein the top surface of the peripheral wall is above the planar wall, providing a decoration element, and
securing the decorative element on top of the planar surface and within the peripheral wall in proximity or contact with the peripheral wall inner surface.

18. A method for using an interchangeable decorative accessory as in claim 17, further comprising the step of providing an emblem on at least one surface of the decorative element.

19. A method for using an interchangeable decorative accessory as in claim 17, wherein the housing is comprised of a material capable of maintaining frictional contact with the decorative element sufficient to secure the decorative element within the peripheral wall,
and further comprising the step of flexing the housing radially outward to accommodate and secure the decorative element.

20. A method for using an interchangeable decorative accessory as in claim 17, further comprising the step of mounting a magnet to either the bottom planar wall or to the decorative element,
and mounting s second magnet to the other of these that is attracted to the first magnet, or wherein the other of these is comprised of a magnetically attractive material.
